(19) United States
(12) Patent Application Publication
(10) Pub. No.: US 2026/0222319 A1
(43) Pub. Date: Jul. 30, 2026

(54) MACHINE-LEARNING CLASSIFIER-BASED RECOGNITION OF CHANNEL IMPAIRMENTS INCLUDING ENVIRONMENTAL CONDITIONS USING RADIO SIGNAL DATA

(71) Applicant: Qoherent Inc., Markham (CA)

(72) Inventors: Ashkan Eshaghbeigi, Toronto (CA); Lorne Swersky, Toronto (CA); Adrian Kaczmarczyk, Guelph (CA); Alec Digby, Guelph (CA); Pasquale Leone, Toronto (CN); Gillian Ford, Mississauga (CA)

(21) Appl. No.: 19/451,471

(22) Filed: Jan. 16, 2026

Related U.S. Application Data
(60) Provisional application No. 63/751,726, filed on Jan. 30, 2025.

(51) Int. Cl. H04L 41/50

(52) U.S. Cl. CPC H04L 41/50

(57) ABSTRACT

System and method of training and deploying an artificial intelligence (AI) machine learning (ML) neural network in recognizing channel impairment in a satellite communication network. Advantageously, the system and method provide radio inference-based environmental monitoring. The method includes providing, via one or more input layers of the ML neural network, a training dataset of communication channel modulation schemes with the satellite communication network, the training dataset of modulations selected in accordance with encoding a digital information signal based on varying an amplitude, a phase, and a frequency of a transmitted signal. The ML neural network includes the input layers interconnected with an output layer via fully connected intermediate layers. Each intermediate layer includes an initial matrix of weights.

### TECHNICAL FIELD

Disclosures herein relate to machine learning based recognition of channel impairment in radio frequency signal satellite communication systems.

### BACKGROUND

The spectrum environment for the satellite communications industry is becoming congested, contested, and complex, due to increasingly larger satellite constellation deployments. In context of communication systems more generally, the term channel impairment refers to the degradation of signal quality caused by factors in including, but not necessarily limited to, Doppler shift, significant path loss, interference, rain attenuation and other environmental conditions. While these factors affect all radio communication systems, they are particularly problematic for <satellite communication channels, essentially weakening transmission signal quality due to various atmospheric and environmental conditions during transmission through space. Channel impairment can adversely impact reliability and performance data transmission between satellites, base stations and user terminals on the ground.

5G is based on OFDM (Orthogonal frequency-division multiplexing), a method of modulating a digital signal across several different channels to reduce interference. Digital modulation is the process of encoding a digital information signal based on varying the amplitude, phase, or frequency of the transmitted (or carrier) signal. The encoding is associated with a code rate that has implications for the signal's ability to withstand channel impairments. A particular digital modulation scheme defines the number of bits that can be carried, in accordance with 5G modulation schemes including QPSK (2 bits), 16 QAM (4 bits), 64 QAM (6 bits), and 256 QAM (8 bits), where the code rate defines the useful proportion of bits transmitted.

### BRIEF DESCRIPTION OF THE DRAWINGS

Whereas novel aspects believed characteristic of the invention are set forth in the appended claims, embodiments described herein will be understood with reference to the following detailed description and accompanying drawing figures, in which like reference numerals indicate similar or identical features and components.

FIG. 1 illustrates, in an example embodiment, a machine learning classifier-based system for recognition of channel impairment in a satellite communication system.

FIG. 2 illustrates, in an example embodiment, an architecture of a control module in accordance with a machine learning classifier-based system for recognition of channel impairment in a satellite communication system.

FIG. 3 illustrates, in an example embodiment, a method of training a machine learning neural network classifier for recognition of channel impairment in a satellite communication system.

FIG. 4 illustrates, in an example embodiment, a method of validating a machine learning neural network classifier for recognition of channel impairment in a satellite communication system.

FIG. 5 illustrates, in an example embodiment, a method of deploying a machine learning neural network classifier for mitigating channel impairment in a satellite communication system.

FIG. 6 illustrates, in an example embodiment, a method of testing a machine learning neural network classifier deployed in recognizing and mitigating channel impairment in a satellite communication system.

FIG. 7 illustrates a confusion matrix obtained while training an ML model according to an example embodiment.

FIGS. 8a and 8b are schematic representations of a regression algorithm applied to training data.

FIGS. 9a-9k are schematic representations of different embodiments of performing inference with the channel impairment processor in different devices.

FIG. 10 is a schematic representation of training multiple models for different inference nodes and deploying thereto.

FIG. 11 is a variation of FIG. 10 wherein different receivers deploying a model to associated receivers.

FIG. 12 is a schematic representation of a fully deployed virtual weather monitoring system.

FIG. 13 is a schematic representation of an implementation in a satellite environment, showing the tensor feature uplink and impairment descriptor and confidence data in the downlink.

### DETAILED DESCRIPTION

Embodiments herein, among other aspects, provide systems and methods of training and deploying an artificial intelligence (AI) machine learning (ML) neural network classifier in recognizing and mitigating channel impairment in a satellite communication system, including space- or terrestrial-based satellite sensing and communications.

In particular, provided is a method of training an artificial intelligence (AI) machine learning (ML) neural network in recognizing communication signals-based channel impairment (“channel impairment”) in a satellite communication network. The method comprises providing, via one or more input layers of the ML neural network, a training dataset of communication channel modulation schemes associated with the satellite communication network, the training dataset of modulations selected in accordance with encoding a digital information signal based on varying at least one of an amplitude, a phase, and a frequency of a transmitted signal, the ML neural network having the one or more input layers interconnected with an output layer via a set of connected intermediate layers of the ML neural network, each of the set of connected intermediate layers including an initial matrix of weights; training a ML classifier to minimize a loss function defined over labeled training data; and adjusting the initial matrix of weights thereby to iteratively increase the correlation between the training dataset and at least one channel impairment parameter as generated at the output layer.

The method, in some embodiments, includes providing a validation dataset of communication channel modulations associated with the satellite communication network, and validating the ML neural network based on at least one of a minimizing loss function and an accuracy function expressed in accordance with the validating the machine learning model using a validation dataset by assessing model performance on previously unseen data, including evaluating at least one of prediction accuracy, loss, error, or confidence measures

In other embodiments, the method further includes deploying the trained ML neural network. In some embodiments, the deploying includes receiving, in real time, a set of transmitted satellite communication signals, recognizing, in accordance with the ML classifier, a channel impairment condition associated with one or more of the satellite communication channels, and generating, in association with the trained AI neural network, one or more channel impairment mitigation actions.

In some embodiments, the method includes reserving, as a test dataset, a set of middle order modulations from each of the training dataset and the validation dataset, and performing testing on the test dataset as to whether the ML neural network model is able to accurately classify the ML model in accordance with treating the middle order modulations as previously unencountered, or previously unseen, data.

Also provided is a wireless network including one or more satellite communication systems. This network can be implemented as a 5G RAN or any other protocol. The network includes a control module in communication with at least one of a satellite communication device, a base station communication device, and a user equipment (UE). The control module includes one or more processor devices and a memory storing instructions executable in the one or more processor devices, the instructions causing the one or more processor devices to execute operations comprising providing, via one or more input layers of the ML neural network, a training dataset of communication channel modulation schemes associated with a satellite communication network, the training dataset of modulations selected in accordance with encoding a digital information signal based on varying at least one of an amplitude, a phase, and a frequency of a transmitted signal, the ML neural network having the one or more input layers interconnected with an output layer via a set of connected intermediate layers of the ML neural network, each of the set of fully connected intermediate layers including an initial matrix of weights; training a machine learning (ML) neural network classifier to minimize a loss function defined over labeled training data; and adjusting the initial matrix of weights thereby to iteratively increase the correlation between the training dataset and at least one channel impairment parameter as generated at the output layer.

Further provided is a non-transitory computer readable medium storing instructions executable in one or more processor devices. The instructions, when executed in the one or more processors, cause the one or more processor to implement operations comprising: providing, via one or more input layers of a ML neural network, a training dataset of communication channel modulation schemes associated with a satellite communication network, the training dataset of modulations selected in accordance with encoding a digital information signal based on varying at least one of an amplitude, a phase, and a frequency of a transmitted signal, the ML neural network having the one or more input layers interconnected with an output layer via a set of fully connected intermediate layers of the ML neural network, each of the set of fully connected intermediate layers including an initial matrix of weights; training a machine learning (ML) neural network classifier based at least in part upon generating, at an output layer of the ML neural network, a correlation between the training dataset and at least one channel impairment parameter generated at the output layer; and adjusting the initial matrix if weights thereby to iteratively increase the correlation between the training dataset and at least one channel impairment parameter as generated at the output layer.

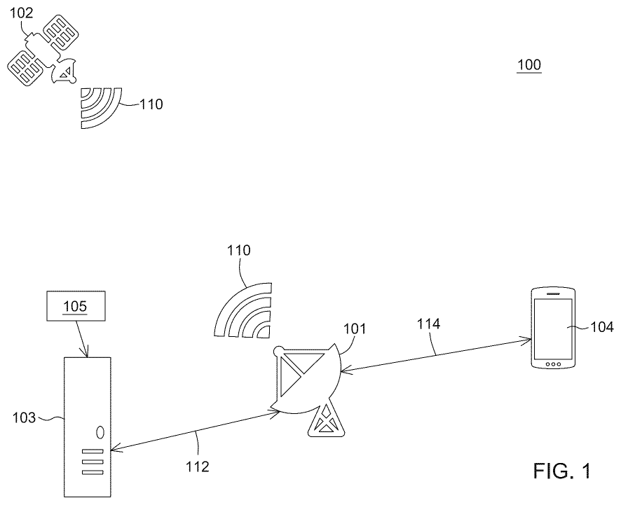

FIG. 1 illustrates, in an example embodiment, a machine learning classifier-based system for recognition of channel impairment in satellite communication system 100. In embodiments, machine learning based satellite communication system 100 includes base station communication device 101 communicatively coupled to satellite communication server computing system 103 and, in some cases, to user equipment 104. Satellite communication server computing system 103 provides executable logic instructions constituting a control module for satellite communication server computing system 103. Base station communication device 101 is in wireless radio frequency (RF) communication with satellite communication device 102, representing any number of orbiting satellite communication devices 102a . . . n. Base station communication device 101 and satellite communication device 102 are equipped with RF antenna arrays to enable RF communication therebetween, each antenna array including various configurations of antenna elements. In embodiments, satellite communication server computing system 103 incorporates executable logic instructions that comprise channel impairment classifier logic module 105.

In one embodiment, the radio front end of the communication node acquires complex baseband in-phase and quadrature samples at a sampling rate selectable between 5 Msps and 120 Msps, with receive bandwidths of 5 MHz, 10 MHz, 20 MHz, 40 MHz, 100 MHz and an analog-to-digital conversion resolution of 12-14 bits. Coarse carrier frequency offset is estimated by periodogram peak detection over 4096-sample blocks and corrected by a numerically controlled oscillator. Timing offset is estimated using a Schmidl-Cox metric or correlation to known pilot structures when present on the link. Amplitude normalization is performed by dividing the IQ sequence by the running root-mean-square magnitude computed over a sliding window of 2048 samples, and DC offsets in I and Q are removed using exponential moving-average subtraction with a decay factor of 0.99.

The communication node forms a feature representation from the IQ samples comprising at least one of a time-domain vector, a frequency-domain vector, or a combination of both, into a time-frequency tensor. In a particular example, a short-time Fourier transform spectrogram is produced by applying a Hann window and a fast Fourier transform (FFT) of size 1024 with 50% overlap to generate frames having 512 frequency bins and 200 time frames over a 200 ms interval. Alternatively, time-domain higher-order cumulants C₂₀, C₂₁, C₄₀ and cyclostationary spectral correlation density at selected cycle frequencies (e.g., symbol rates of signals of interest) are computed from 10 ms segments to form a feature vector sensitive to nonlinearities and periodicities degraded by channel impairments.

In some embodiments, base station communication device 101 and satellite communication server computing system 103 may be included in a mobile platform, rather than a fixed platform or location. In some embodiments, is contemplated that the logic instructions that constitute channel impairment classifier logic module 105 may be hosted, partially or otherwise, in other computing or server system communicatively coupled to satellite communication server computing system 103 within, or communicatively accessible to, satellite communication system 100, as will be apparent to those of skill in the art of computer and communication networks.

In a particular embodiment, satellite communication system 100 may be a 5G network implementation. More particularly, a 5G RAN (Radio Access Network) which can include a satellite antenna, allowing for the integration of satellite connectivity to extend 5G coverage to remote areas where terrestrial infrastructure is limited, essentially providing a “non-terrestrial network” (NTN) capability within the 5G system; this is becoming increasingly common as satellite technology evolves to support 5G standards. In another embodiment, satellite communication system 100 may be operating on open protocols or proprietary links, or according to standards, such as DVB-S2X.

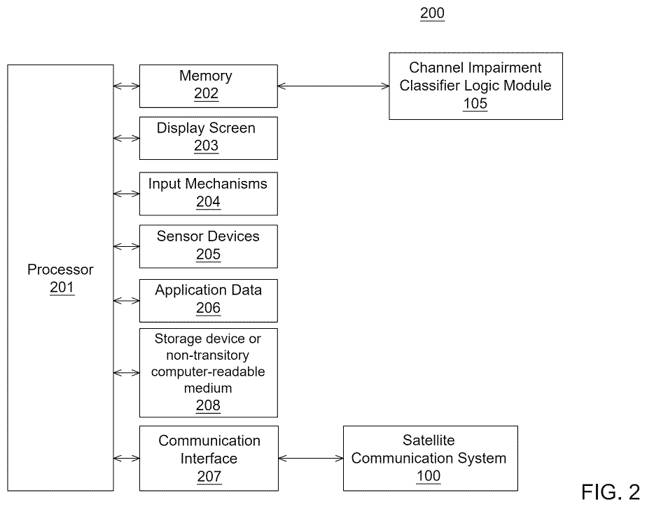

FIG. 2 illustrates, in an example embodiment, architecture 200 of a control module in accordance with a machine learning classifier-based system for recognition of channel impairment in a satellite communication system 100. Architecture 200, in embodiments, may be implemented on, for example, a server or combination of servers, or reside on base communication station 101. In one implementation, architecture 200 includes processor 201, memory resources 202 (e.g., read-only memory (ROM) or random-access memory (RAM)), and communication interface 207 communicatively coupled within satellite communication system 100. Memory resources 202 may include instructions, constituting channel impairment classifier logic module 105, that are executable in processor 201. Memory resources 202 may also be used to store temporary variables or other intermediate information during execution of program instructions by processor 201.

To improve sensitivity to impairment classes of interest, the feature representation may be enriched with subband-specific measurements. In one implementation, the device computes per-subband received signal strength indicator (RSSI) and carrier-to-noise ratio (C/NO) over 100 kHz subbands, aggregating mean, variance, and percentiles (p10, p50, p90) over 5-10 consecutive frames to yield a subband tensor of shape [B, T, F], where B is the number of subbands, T is the number of time frames, and F is the number of statistics. A Doppler spectrum is derived by taking an FFT across time frames of pilot tone estimates, providing a frequency-shift distribution with 1-5 Hz resolution. Interference features include spectral flatness and spectral entropy per subband, as well as kurtosis of amplitude distributions indicative of impulsive interference. A person skilled in the art will appreciate that the figures given above are illustrative, and will vary depending on the end user, the features expected and the computational resources available.

In embodiments configured for non-terrestrial links, the device logs satellite ephemerides and elevation angles when available; the geometry may be appended to the feature vector to enable the model to disambiguate impairments due to geometry (e.g., low elevation multipath) from atmospheric phenomena. Generally, the direction of the target as determined by ephemeris data, antenna elevation/azimuth, phased-array direction finding can all be valuable inputs to the model.

Architecture 200 may include display screen 203 and input mechanisms 204. As described by various examples, processor 201 can detect and process any number of sensor inputs from input sensor devices 205. By way of example, such sensor inputs can include, but are not necessarily limited to, various sensor devices providing physical parameter measurements related to timing of signals as received from satellite navigation service, orbital mechanics of one or more satellites relative to properties of signals as propagated, RF signal characteristics in relation to satellite geospatial parameters, carrier-to-noise ratio associated with a satellite elevation relative to the receiver device 101, observed obstruction and signal propagation effects across frequency bands, and observed obstruction and signal propagation effects in relation to satellite geospatial parameters.

In addition to physical phenomena and physical parameters as sensed by sensor devices 205, system 200 can consume various kinds of inputs to represent context. For example, the system can be connected to a live calendar application, or similar current events application data 206 that indicates whether a high traffic event is taking place in the receiver device local surroundings. This can be a useful measure of context since a busy day may imply a noisier RF environment. In embodiments, application data module(s) 206 may be communicatively and logically accessible to processor 201 to augment information as acquired in accordance with sensor devices 205.

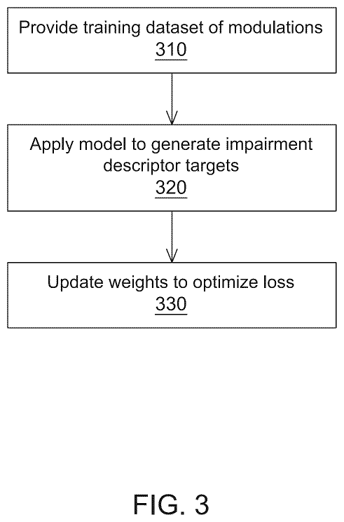

As such, examples described herein are related to the use of the computer system 200 for implementing the techniques described herein. According to an aspect, techniques are performed by way of architecture 200 in response to the processor 201 executing one or more sequences of one or more instructions contained in memory 202. Such instructions may be read into memory 202 from another machine-readable medium. Execution of the sequences of instructions contained in memory 202 causes the processor 201 to perform the process steps described herein, including process steps of the embodiments described herein in conjunction with, for example, the embodiments as described in FIGS. 3-6 herein. In alternative implementations, hard-wired circuitry may be used in place of or in combination with software instructions to implement examples described herein. Thus, the examples described are not limited to any specific combination of hardware circuitry and software.

In some embodiments, communication interface 207 provides bi-directional communication and computing accessibility between satellite communication server computing system 101, including channel impairment classifier logic module 105 constituted therein, and other devices and systems of satellite communication system 100 as depicted in FIGS. 1-6 and described herein.

In embodiments, channel impairment classifier logic module 105 of memory 202 includes logic instructions executable in processor 201. In embodiments, channel impairment classifier logic module 105 includes instructions for providing, via one or more input layers of the ML neural network, a training dataset of communication channel modulation schemes, or modulations as variously referred to herein, associated with the satellite communication network, the training dataset of modulations selected in accordance with encoding a digital information signal based on varying at least one of an amplitude, a phase, and a frequency of a transmitted signal, the ML neural network having the one or more input layers interconnected with an output layer via a set of fully connected intermediate layers of the ML neural network, each of the set of fully connected intermediate layers including an initial matrix of weights.

In some embodiments, the modulations comprise one or more of phase-shift keying (PSK) and quadrature amplitude modulation (QAM) schemes. In particular implementations, the PSK and QAM schemes may be based on a coding rate in accordance with at least one of BPSK, QPSK, 8PSK, 16APSK, 32APSK, 128APSK, 256APSK, PAM14, 16QAM, 32QAM, 64QAM, 128QAM and 256QAM.

Channel impairment classifier logic module 105 also includes instructions for training a ML classifier to minimize a loss function defined over labeled training data.

Channel impairment classifier logic module 105 includes instructions for adjusting the initial matrix of weights thereby to iteratively increase the correlation between the training dataset and at least one channel impairment parameter as generated at the output layer.

In some embodiments, channel impairment classifier logic module 105 also includes instructions for providing a validation dataset of communication channel modulations associated with the satellite communication network. In some examples, validating the ML neural network may be based on at least one of a training loss function and an accuracy function expressed in accordance with the validating the machine learning model using a validation dataset by assessing model performance on previously unseen data, including evaluating at least one of prediction accuracy, loss, error, or confidence measures. In some instances, the training loss function comprises a total training loss and a total validation loss over a given number of training epochs, and the accuracy function comprises a total training accuracy and a total validation accuracy over the given number of training epochs.

In some aspects, channel impairment classifier logic module 105 also includes instructions for reserving, as a test dataset, a set of middle order modulations from each of the training dataset and the validation dataset, and performing testing on the test dataset as to whether the ML neural network model is able to accurately classify the channel model in accordance with treating the middle order modulations as previously unencountered data.

In another aspect, channel impairment classifier logic module 105 further includes logic instructions for deploying the trained ML neural network based on receiving, in real time, a set of transmitted satellite communication signals. Then recognizing or detecting, by the ML classifier, a channel impairment condition associated with one or more of the satellite communication channels, and generating, in association with the trained ML neural network, one or more channel impairment mitigation actions. The channel mitigation actions, in some example embodiments, may comprise one or more of applying an advanced modulation techniques incorporating error correction coding, adaptive transmission power control, beamforming antennas to focus the signal towards specific user terminals thereby minimizing signal spread and improving signal strength, Doppler shift compensation, channel estimation and prediction, diverse routing, and coordinated spectrum management with terrestrial networks to optimize signal quality and minimize interference, despite the long distances and challenging propagation conditions involved in satellite links. In some examples, deployment of the trained ML neural network classifier may be contingent upon establishing that correlation with a channel impairment condition exceeds a predetermined threshold of probabilistic confidence level.

Channel impairment classifier logic module 105 also includes logic instructions for fine-tuning the trained ML neural network model by applying a pruning procedure that reduces the intermediate layers of the ML neural network, and also input layers and hidden layers, for instance in a convolutional neural network (CNN) implementation embodiment. The pruned input layers and intermediate or hidden layers may be removed if found in fact not to impact or influence performance of the classifier. Thus, a fine-tuned, minimum-parameter count ML neural network model may be produced. In this manner, higher computational efficacy and faster computational response times, among other technical advantages and benefits, can be achieved, for example by satellite communication server computing system 103, in accordance with such minimum-parameter count ML neural network model.

FIG. 3 illustrates, in another example embodiment, method 300 of training a machine learning neural network classifier for recognition of channel impairment in satellite communication system 100. Examples of method steps described herein are related to deployment and use of machine learning based satellite communication system 100 as described herein, in conjunction with any of the techniques, method steps, devices and systems as described in regard to FIGS. 1-6 herein. According to one embodiment, the techniques are performed in processor 201 executing one or more sequences of software logic instructions that constitute channel impairment classifier logic module 105. In embodiments, instructions constituting channel impairment classifier logic module 105 may be read into memory 202 from machine-readable medium, such as memory storage devices. Executing the instructions of channel impairment classifier logic module 105 stored in memory 202 causes processor 201 to perform the process steps described herein. In alternative implementations, at least some hard-wired circuitry, including but not limited to field programmable gate array (FPGA) implementations, may be used in place of, or partly in combination with, the software logic instructions that constitute channel impairment classifier logic module 105 in order to implement example embodiments described herein. Thus, the examples described herein are not limited to any particular combination of hardware circuitry and software instructions.

In one embodiment presented for illustration, the trained model is a two-head neural network operating on spectrogram inputs of size 200×512×1. The network comprises: a convolutional block Conv(32 filters, 3×3 kernel, stride 1) with rectified linear unit (ReLU); a second Conv(32, 3×3) with ReLU; MaxPool(2×2); Conv(64, 3×3) with ReLU; Conv(64, 3×3) with ReLU; MaxPool(2×2); Conv(128, 3×3) with ReLU; GlobalAveragePooling; followed by a Dense(128) layer with ReLU and Dropout(0.3). Two output heads are provided: (i) a classification head Dense(K) with Softmax to output K channel-impairment classes including Doppler shift band, rain attenuation level, multipath delay spread band, and interference type; and (ii) a regression head Dense(M) to output M environmental parameters including temperature (° C.), pressure (kPa), relative humidity (%), visibility (km), precipitation rate (mm/h), and wind speed (m/s). The classification loss is categorical cross-entropy; the regression loss is mean-squared error; the combined loss is L=λ_{c}L_{cls}+λᵣL_{reg} with λ_{c}=1.0 and λᵣ=0.5.

An alternative architecture uses a transformer encoder applied to a sequence of subband feature vectors. The encoder comprises 4 layers, each with multi-head self-attention (8 heads, key dimension 64), layer normalization, and positionwise feed-forward blocks of size 256 with Gaussian error linear unit (GELU) activations. Learned positional encodings are applied to the input sequence. The output token sequence is pooled by attention to form a 256-dimensional embedding fed to the dual-head classifier and regressor.

Training employs the AdamW optimizer with learning rate 1×10⁻³, weight decay 1×10⁻⁴, and a cosine decay schedule over 50 epochs. Batch size is 64, with early stopping on validation loss with patience 7 epochs. Weights are initialized via He normal initialization for convolution layers and Xavier uniform for dense layers.

At step 310, providing, via one or more input layers of the ML neural network, a training dataset of communication channel modulation schemes (also referred to herein as “modulations”) associated with the satellite communication network. The training dataset of modulations may be selected in accordance with encoding a digital information signal based on varying one or more of an amplitude, a phase, and a frequency of a transmitted signal. As instantiated in the one or more processor devices 201 in conjunction with instructions stored in memory 202, the ML neural network may be constituted of one or more input layers interconnected with an output layer via a set of fully connected intermediate layers of the ML neural network, each of the set of fully connected intermediate layers including an initial matrix of weights, or filters.

At step 320, training a ML classifier to minimize a loss function defined over labeled training data.

At step 330, adjusting the initial matrix of weights thereby to iteratively increase the correlation between the training dataset and at least one channel impairment parameter as generated at the output layer. In example embodiments, the initial matrix of weights, or filters, may be iteratively adjusted using backpropagation.

In some variations, the method further includes providing a validation dataset of communication channel modulations associated with the satellite communication network. In some examples, validating the ML neural network may be based on at least one of a training loss function and an accuracy function expressed in accordance with the validating the machine learning model using a validation dataset by assessing model performance on previously unseen data, including evaluating at least one of prediction accuracy, loss, error, or confidence measures. The training loss function, in some embodiments, may comprise a total training loss and a total validation loss over a given number of training epochs. The accuracy function, in related embodiments, comprises a total training accuracy and a total validation accuracy over the given number of training epochs.

In some aspects, the method further comprises reserving, as a test dataset, a set of middle order modulations from each of the training dataset and the validation dataset. In such example embodiments, the method further includes performing testing on the test dataset as to whether the ML neural network model is able to accurately classify the channel model in accordance with treating the middle order modulations as previously unencountered, or previously unseen, data.

Ground-truth environmental labels are ingested at 5-minute intervals (although shorter intervals are better) from a weather-station data service. In the case of multiple weather stations that are within this distance, it is possible to interpolate between these multiple station's data with the intention of creating a more accurate representation of the current weather at the receiving site. In one such method for interpolating between the different weather stations is given herestations within a user-specified distance of 5 km from the communication node were employed, with timestamps synchronized to GPS time. When multiple stations are within the radius, inverse-distance weighting is used to compute a composite label. Labels include temperature, pressure, relative humidity, visibility, precipitation rate, wind speed, and wind direction. Spatial offsets are computed by Haversine distance; outliers are removed using a median absolute deviation filter with threshold 3.5.

To improve robustness, augmentation applies synthetic channel models to clean IQ recordings: Rayleigh and Rician fading (K-factor uniform on [0, 10]), Doppler shifts uniformly sampled in [−100 Hz, +100 Hz] for L-band and scaled for higher bands, additive white Gaussian noise with SNR uniformly sampled in [0 dB, 30 dB], and rain attenuation per ITU-R P.838-3 with rainfall rates in [0, 50] mm/h and frequency-dependent specific attenuation γ_{R} in dB/km. In one example, interference is simulated as narrowband tones and OFDM-like multi-carrier interferers placed at random subbands with power 10-30 dB above noise floor. The dataset is split 70% training, 15% validation, 15% test, with “middle order modulations” (e.g., 16QAM, 8PSK, 16APSK) reserved exclusively in the test set to evaluate generalization to previously unseen modulations. It will be appreciated that as more parameters are decided at random (unpredictably to the model) during training, the more general and resilient the model's interference recognition abilities become.

In one example embodiment, the ML neural network comprises a convolutional neural network (CNN) model.

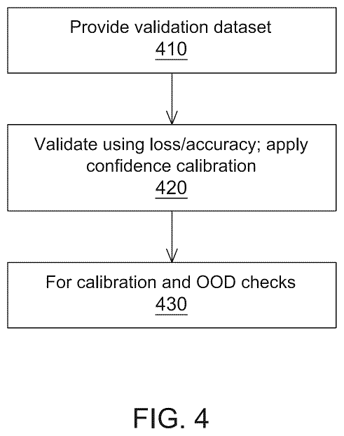

FIG. 4 illustrates, in an example embodiment, method 400 of validating a machine learning neural network classifier for recognition of channel impairment in satellite communication system 100. Examples of method steps described herein are related to deployment and use of machine learning based satellite communication system 100 as described herein, in conjunction with any of the techniques, method steps, devices and systems as described in regard to FIGS. 1-4 herein. According to one embodiment, the techniques are performed in processor 201 executing one or more sequences or configurations of software logic instructions that constitute channel impairment classifier logic module 105. In embodiments, instructions constituting channel impairment classifier logic module 105 may be read into memory 202 from machine-readable medium, such as memory storage devices. Executing the instructions of channel impairment classifier logic module 105 stored in memory 202 causes processor 201 to perform the process steps described herein. In alternative implementations, at least some hard-wired circuitry, including but not limited to field programmable gate array (FPGA) implementations, may be applied in place of, or in combination with, the software logic instructions that constitute channel impairment classifier logic module 105 in order to implement example embodiments described herein. Thus, the examples described herein are not limited to any particular combination of hardware circuitry and software instructions.

At step 410, providing a validation dataset of communication channel modulations associated with the satellite communication network.

Confidence gating is applied to classification outputs using temperature-scaled Softmax, where the temperature Tis learned on a held-out calibration set to minimize negative log-likelihood. For regression outputs, conformal prediction intervals are computed using residual-based quantile regression to produce 90% prediction intervals; environmental parameters are withheld when interval width exceeds application thresholds (e.g., visibility interval >4 km). Out-of-distribution detection is performed by computing an energy score over the penultimate layer; samples with energy above a trained threshold or with Mahalanobis distance exceeding a predetermined value are flagged as OOD and bypass channel-control actions.

At step 420, the ML neural network as trained may be validated based on a training loss function and an accuracy function expressed in accordance with the validating the machine learning model using a validation dataset by assessing model performance on previously unseen data, including evaluating at least one of prediction accuracy, loss, error, or confidence measures as selected or provided. In particular example embodiments, the training loss function may comprise a total training loss and a total validation loss over a given number of training epochs, and the accuracy function may comprise a total training accuracy and a total validation accuracy over that number of training epochs.

In some aspects, the training operations may be continually repeated with a goal of optimizing model parameters to minimize a loss function defined over labeled training data representing channel impairment conditions, until one or more performance criteria are satisfied, the performance criteria comprising at least one of a classification accuracy, a loss value, a confidence score, or a probabilistic output metric meeting or exceeding a predetermined threshold.

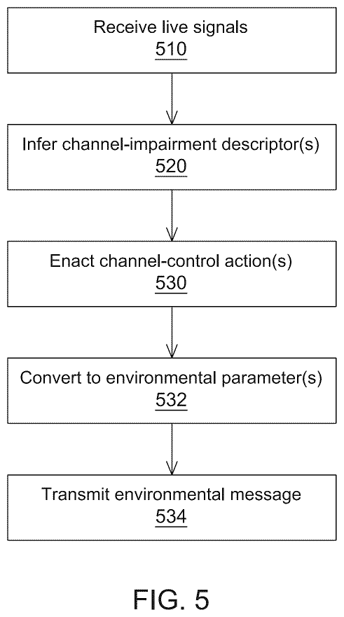

FIG. 5 illustrates, in an example embodiment, method 500 of deploying a machine learning neural network classifier for mitigating channel impairment in satellite communication system 100. In the example embodiment depicted in FIG. 5, the ML based classifier may be deployed in conjunction with the steps as described herein with regard to any one of FIG. 3 or FIG. 4.

At step 510, further fine-tuning the trained ML neural network classifier by applying a pruning procedure that reduces branches and layers of the ML neural network, including input layers and intermediate or hidden layers in a convolutional neural network implementation embodiment, for instance, which are operationally are not in fact impacting or influencing classification in accordance with producing a minimum-parameter count ML neural network model. In this manner, higher computational efficacy and faster computational response times, among other technical advantages and benefits, can be achieved, for example by satellite communication server computing system 103, in accordance with such minimum-parameter count ML neural network model.

For on-device inference, in one embodiment, the network is pruned using structured channel pruning based on L1-norm saliency to achieve 50% channel sparsity in convolutional layers. Knowledge distillation transfers logits from the trained teacher to a compact student model with 50% fewer parameters using a distillation temperature of 2. Quantization-aware training yields INT8 weights and activations compatible with ARM NEON and NVIDIA Jetson platforms. On a base station x86 server (AVX2), latency per inference on a 200×512 spectrogram is 2.3 ms; on a satellite payload processor (ARM Cortex-A53), latency is 18 ms after pruning and INT8 quantization; on a UE-class system-on-chip, latency is 35 ms with batch size 1.

Preferably, channel-control actions are derived from impairment descriptors via a decision table. For example, when inferred rain attenuation exceeds 2 dB/km with confidence 0.9, the node reduces modulation order by one step and increases coding redundancy by selecting a rate-1/2 code; when Doppler rate exceeds 30 Hz/s with confidence 0.8, the node applies a third-order polynomial Doppler compensation and increases pilot density by 25%. Power control uses a proportional-integral controller with step size 0.5 dB and a maximum adjustment of 3 dB per 100 ms. Hysteresis prevents oscillations by requiring conditions to persist for two consecutive inference windows. The above figures are for illustration purposes and can be adjusted by a user.

At step 520, recognizing, in accordance with the ML classifier, a channel impairment condition associated with one or more of the satellite communication channels.

At step 530, generating, in association with the trained AI ML neural network, one or more channel impairment mitigation actions. In embodiments, the channel impairment mitigation actions may include any one or more of applying advanced modulation techniques incorporating error correction coding, adaptive transmission power control, beamforming antennas, Doppler shift compensation, channel estimation and prediction, diverse routing, and coordinated spectrum management with terrestrial networks to optimize signal quality, despite the long distances and challenging propagation conditions involved in operation of satellite links.

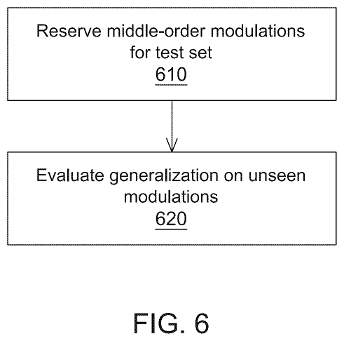

FIG. 6 illustrates, in an example embodiment, method 600 of testing a machine learning neural network classifier deployed in recognizing and mitigating channel impairment in a satellite communication system. For successful deployment in real-world scenarios, test cases that represent real-world conditions are vital. Input data should mimic the user input that the ML model will actually receive in real-world deployment, and it is essential to mimic or use previously unencountered, or previously unseen, input data on which the application will rely. The operations of FIG. 6, although depicted as performed in conjunction with the techniques of FIG. 4, may be performed in conjunction with the techniques, or portions thereof, as described in any one of FIGS. 3-5.

At step 610, reserving, as a test dataset, a set of middle order modulations from each of the training dataset and the validation dataset.

At step 620, performing testing on the test dataset as to whether the ML neural network model is able to accurately classify the channel model in accordance with treating the middle order modulations as previously unencountered data.

The above description presents a system and method for recognizing channel impairment in satellite communications systems. It will be readily apparent to a person skilled in the art that if one can recognize the impairment affecting a particular transmission channel, one can more accurately inform an adaptation strategy to minimize the effect of the given impairment. Not only does the existence (or recognition) of an impairment provide value, there is even greater value in understanding why a particular impairment is occurring. The above description focuses then on producing a vast dataset of dozens of modulations with unimpaired recordings, and then applied channel models to the recordings, to train a classifier.

Increasing the number of modes for each channel, and training a regressor model on the resulting data was expected to yield an identification of certain aspects that could be quantified.

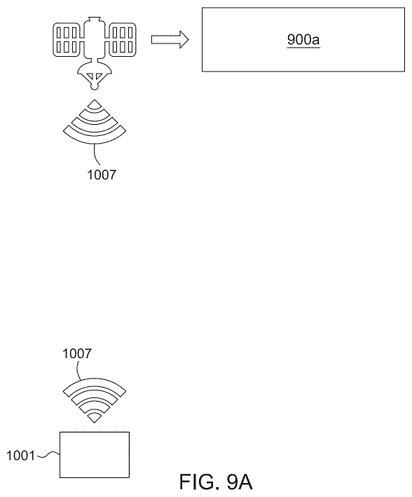

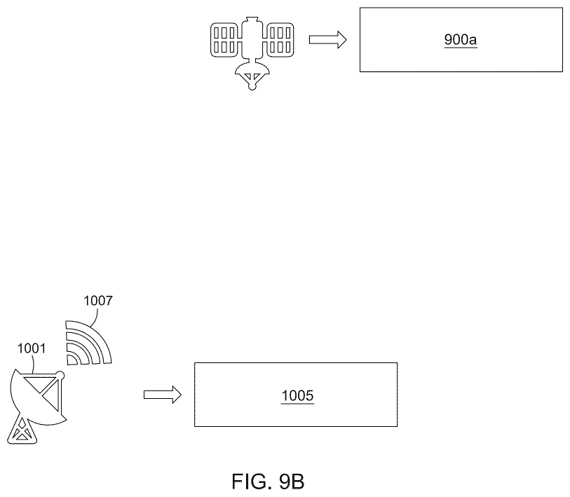

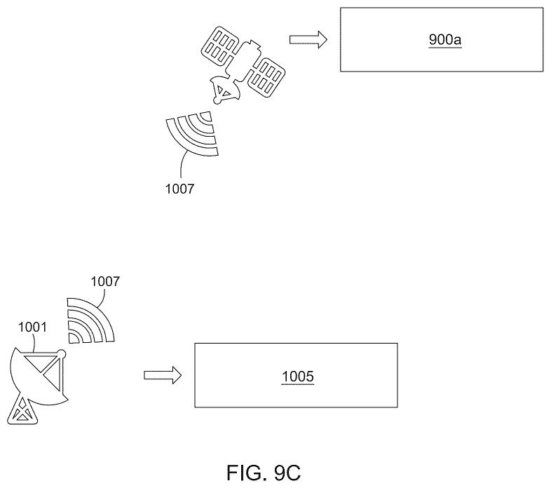

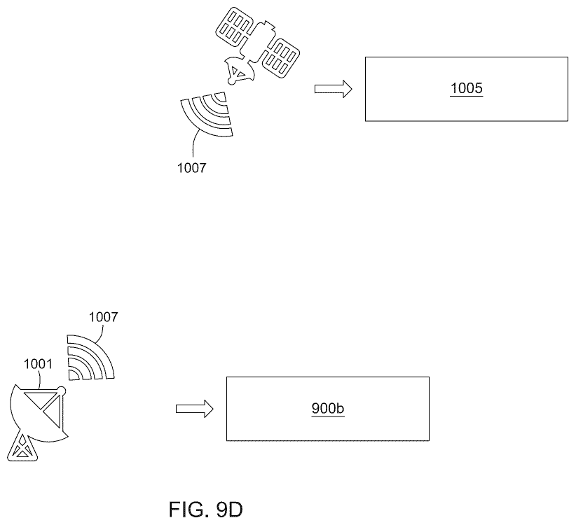

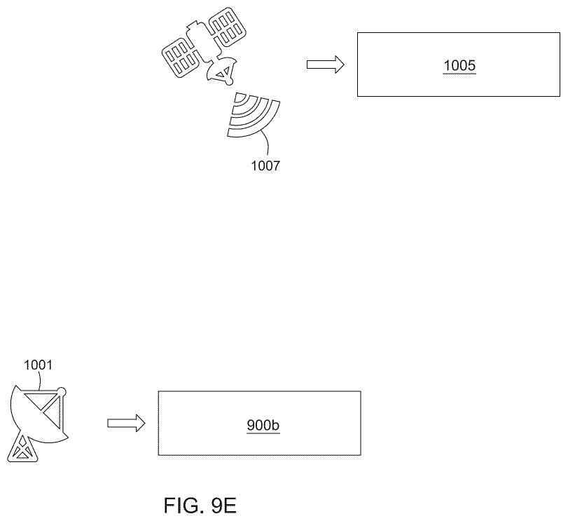

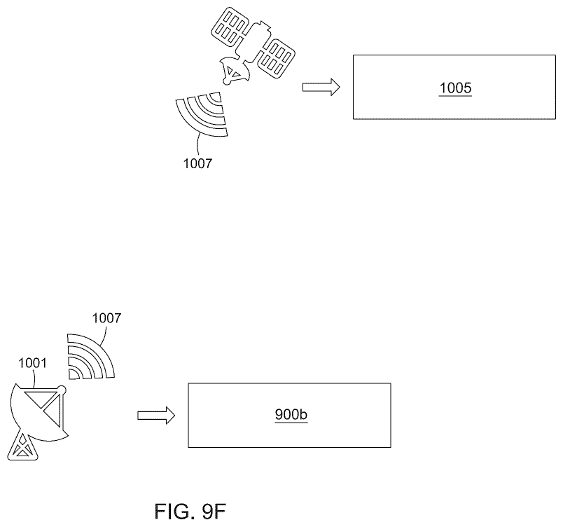

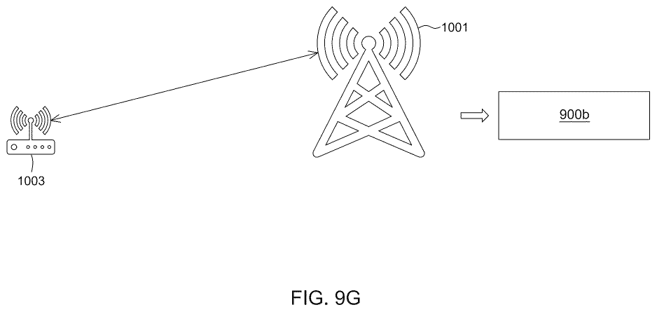

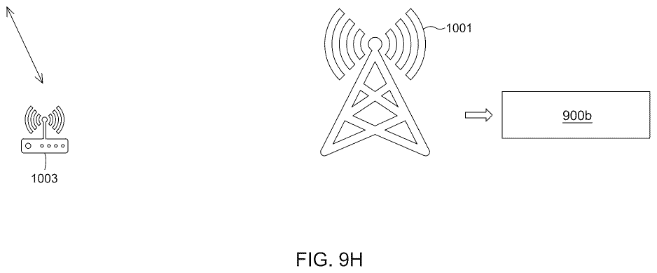

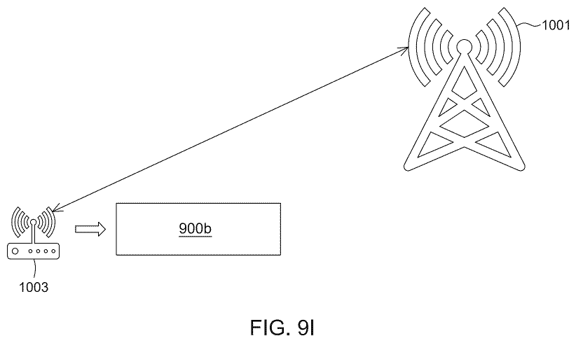

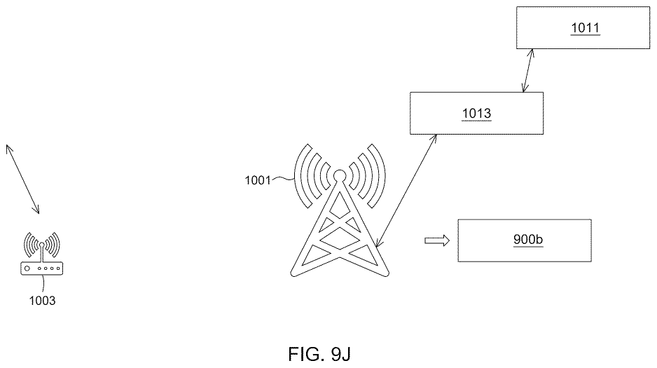

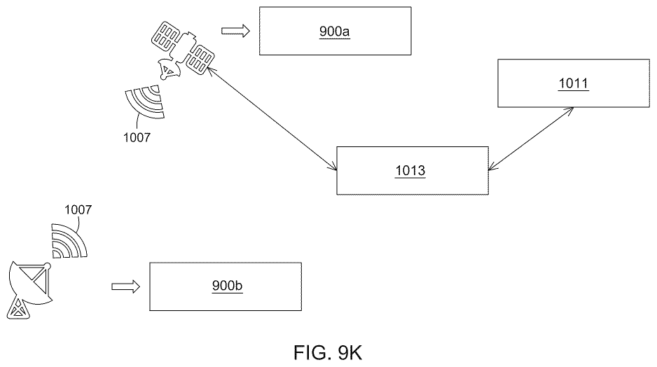

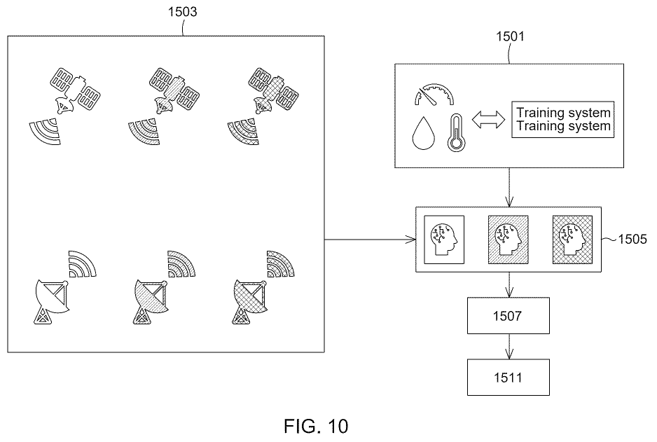

Referring now to FIGS. 9 and 10, there shown a result of applying regression to the model described herein for temperature and pressure. As one can see, while there are non-linearities in the resulting data, it is possible to extrapolate and derive generalities for the data.

One particular advantage of the system and method described herein is that one can look at a channel impairment beyond the traditional impairments (linked to for example the antennae or encoders) and instead look at channel impairments as environmental conditions. In other words, it has been discovered that a channel impairment can in fact be characterized as environmental measurements.

More particularly, as will be apparent below, the appropriate labelling of the channel impairment factors identified can lead to the use of base stations (i.e. in communications networks) as virtual weather stations at scale. In this case, channel model recognition as described above is intrinsically interesting, but the value of the result lies in computing inference on the IQ samples for weather measurement purposes. Stated differently, radio signals propagate through the atmosphere and are degraded due to, among others, environmental conditions. The characterization of the degradation can then be used to calculate weather conditions such as visibility, temperature, humidity, pressure, etc.

Referring now to FIG. 1 again, the ability to characterize channel impairments as environmental conditions was initiated by having two arrangements as shown. Each of the stations 101 was connected to a publicly available datamart of weather conditions. For example, station 101 was connected to Environment Canada's Datamart, which returns labelled weather station data, which can be in the following format:

{ambient_metadata‘: station’: ‘Toronto City
Centre Airport, ‘dateTime’:’’, ‘condition’
‘Clear, ‘iconCode’: ‘30’, ‘temperature’: “11.0”,
‘dewpoint: 5.4”, ‘pressure’:
‘Visibility’: “16.1”, relativeHumidity’ “68”,
‘wind’: speed: 17.0, ‘direction’: ‘NW,
‘bearing’: 320.0}, ‘riseSet’: sunrise’:
“Thursday Oct. 24, 2024 at 11:44 UTC’,
‘sunset’ ‘Thursday Oct. 24, 2024 at
22:19 UTC}

A ML model was trained on the combination of weather station data and captured satellite signals.

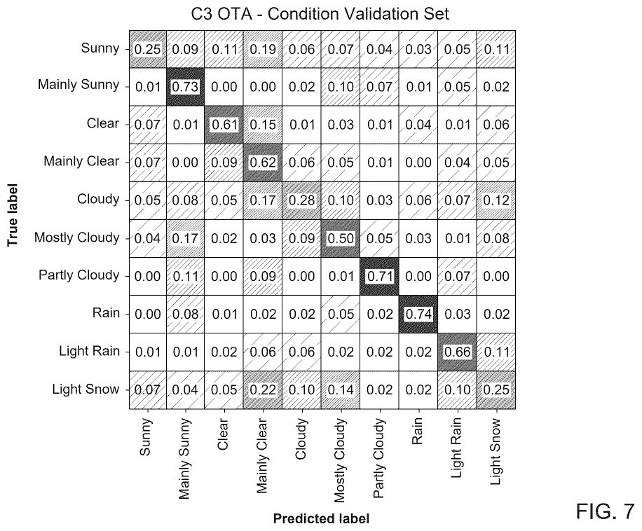

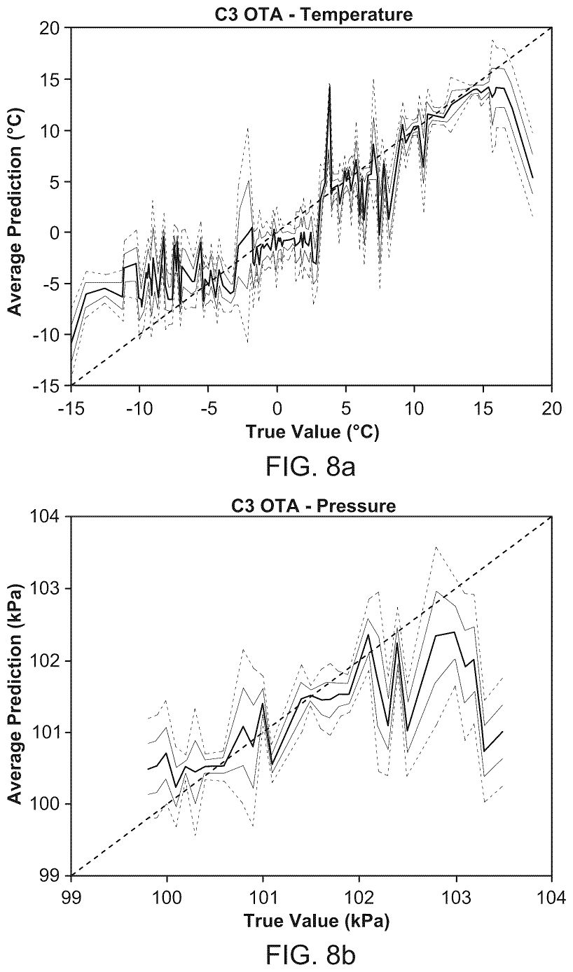

Four datasets are used for evaluation: (1) laboratory IQ captures across modulations at controlled SNRs; (2) augmented synthetic channel models as described above; (3) field captures from live base stations; and (4) downlink captures from L-/S-/C-band satellite links. A person skilled in the art will appreciate that Ku-/Ka-band satellite links are also within the scope of the present disclosure. Performance is reported via confusion matrices for impairment classification and mean absolute error/root-mean-square error for environmental regression. FIG. 7 illustrates a confusion matrix with average precision 0.88 and recall 0.86 across impairment classes. FIGS. 8A-8B depict regression predictions versus ground truth for temperature and pressure; residual plots indicate mild non-linearities mitigated by site-specific calibration.

FIG. 7 is a presentation of the results between predicted labels for environment conditions vs the true labels as reported by the weather station data. The data presented here has undergone cleaning up of the data, labelling, and purging of outlier data, and a person skilled in the art will appreciate that other methods for cleaning data can be applied. It will be apparent that congruence between the actual label and the predicted label is visually striking. Thus, the ability to derive channel impairments from real-time measurements essentially turns each base station into its own local weather station. The ability to deploy the apparatus and method of the instant description to a large number of bases stations can permit more accurate forecasting of present weather conditions. This also allows extracting information from signals received at a satellite, leveraging a vast network of satellites to become an observer for specific weather phenomena. In addition, a collection of bases stations can be leveraged by weather forecasting services to more accurately predict emergent conditions, or to verify the accuracy of a prediction.

Referring now to FIGS. 9a to 9i There are shown various embodiments of the deployment of the channel impairment classifier logic module 105, or channel impairment processor.

For example, in FIG. 9a, the module 105 is aboard a satellite, which is in one embodiment a synthetic radar aperture radar satellite. The module 105, once trained, will perform inference from a raw, reflected signal, in addition to its usual radar tasks.

In FIG. 9b, the module 105 is again on board a satellite, but is not linked to the ground station 1001, and thus is able to capture a signal of interest, or signal or opportunity, unrelated to the satellite functions. Module 105 is nonetheless able to analyze the signal of interest, and obtain weather related data therefrom.

FIG. 9c is a variation on the configuration of FIG. 9b, in that the satellite is linked to a ground station 1001, and leverages the link to analyse the signal of interest for impairments. In this example, the module 105 is still located onboard the satellite.

FIG. 9d is a variation of the configuration of FIG. 9c, in that the module is located on the base station 1001, whereas FIG. 9e is similar to FIG. 9b, but where the module 105 is located on the base station 1001.

FIG. 9f is the configuration where the module 105 is on the base station 1001.

FIG. 9g is a configuration where the module 105 is on a base station 1001, and the base station is linked to a linked device 1003. Linked device can be for example a cellular telephone, a WiFi hotspot, or any other device that may be linked to a base station 1001. In FIG. 9h, the device 1003 is not linked to a base station 1001, but can still, as in the example of FIG. 9b, provide a signal of interest for the module 105.

FIG. 9i illustrates an embodiment where the module 105 is on-board a device 1003, in this case linked to a base station 1001.

As will also be apparent to a person skilled in the art, module 105 is preferably continuously trained, or intermittently re-trained, or both, by linking module 105 to a local weather station. The updated model is then redeployed to the module 105, as shown in FIG. 9j. Similarly, FIG. 9k illustrates the embodiment where the module 105 is on board the satellite, and is also continuously or intermittently updated or re-trained in view of accessible current data provided by a weather station.

FIG. 10 demonstrates the ability of the module 105 of the instant description to be trained and deployed to various nodes. Step 1 starts with obtaining common metadata for local nodes. The inference nodes 2 provide the signal recordings, which are then passed on to the training system. Individual models are produced for each inference node, and the models are then deployed to the various nodes.

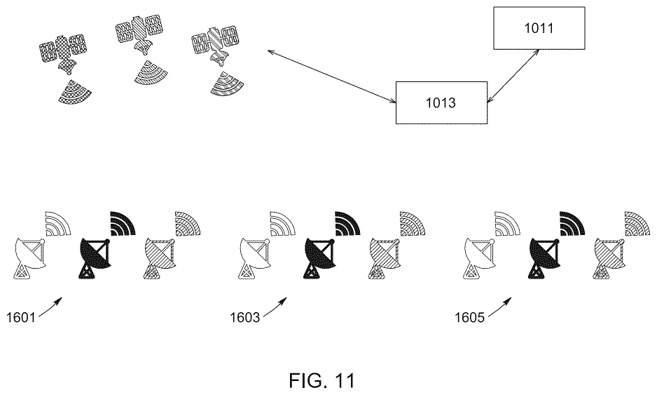

FIG. 11 expands on the example of FIG. 10, by training multiple inference receivers, as well as continuously training the receivers, while deploying the models to individual receivers that are geographically proximate. For example, the group of three receivers on the left of the figure could be in City A, while the group of three receivers in the middle could be in City B, and the last group of three receivers to the right of the Figure could be in City C. Of course, there can be only one receiver or multiple receivers per geographic area, and it is not necessary for each group of receivers to have the same number.

Preferably, continual learning operates on a scheduled cadence (daily, weekly, half-day, etc.), aggregating the prior period's feature tensors and corresponding weather-station labels. Retraining produces an updated model which must pass validation gates including classification regression. Canary deployment is applied to a subset of devices within a geographic cluster; telemetry is monitored for a predetermined period of time prior to full rollout. If telemetry indicates degradation beyond thresholds, automatic rollback to the prior model occurs and retraining parameters are adjusted.

Preferably, in remote inference embodiments, the communication device transmits feature tensors to an inference endpoint using gRPC over TLS 1.3 with mutual authentication via X.509 certificates. Feature tensors are serialized as Protocol Buffers with LZ4 or gzip compression. The device enforces a 50 ms deadline for edge endpoints and a 500 ms deadline for cloud endpoints; exceeding the deadline triggers exponential backoff with jitter and local fallback to a pruned model cached on the device. The server returns a channel-impairment descriptor vector and a confidence score; the device logs inference hashes and signatures to verify integrity. Edge servers may be co-located with base stations and implement GPU acceleration; satellite payload processors may host the model for in-orbit inference when downlink latency is prohibitive.

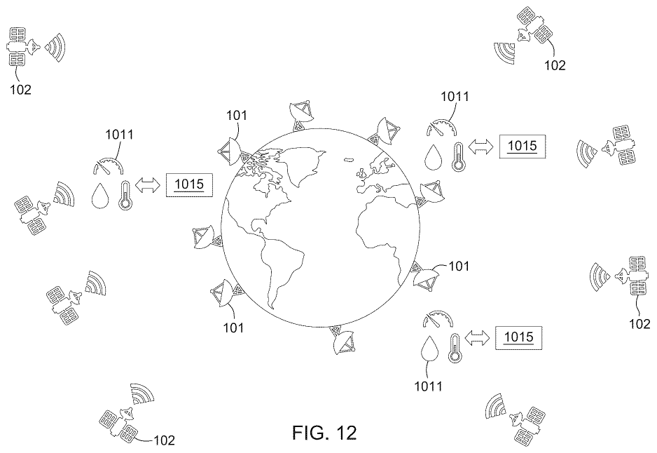

FIG. 12 is an example of a fully deployed, distributed virtual weather monitoring system, comprising a plurality of satellites, weather stations, base stations, each configured according to any one of the examples of FIG. 9a-9k, providing an inexpensive, widely distributed, yet highly localized system for monitoring weather conditions.

Preferably, environmental parameters are calibrated using site-specific regression offsets learned from ground-truth station data. Temperature is output in degrees Celsius, pressure in kilopascals normalized to sea-level via the barometric formula, humidity as percentage relative humidity, visibility in kilometers inferred from multipath spread and scintillation proxies, precipitation rate in mm/h derived from specific attenuation via ITU-R relationships, and wind speed/direction inferred from Doppler spread asymmetry of known broadcast carriers. Validation across 3 urban test sites shows mean absolute error of 1.2° C. for temperature, 0.9 kPa for pressure, 8% RH for humidity, 2.0 km for visibility, and 1.8 mm/h for precipitation rate.

Preferably, the inference stack executes on platforms including x86 servers with AVX2/AVX-512, ARM Cortex-A53/A72, NVIDIA Jetson devices (CUDA-accelerated), and Xilinx Zynq FPGAs. Convolutional layers are accelerated via cuDNN on GPUs and via CMSIS-NN on ARM cores. FPGA implementations instantiate FFT blocks, correlators, and fixed-point CNN layers with INT8 arithmetic and DSP slice utilization below 70%. The software stack employs C++ for real-time signal processing and Python for training; deployment artifacts are exported via ONNX and compiled to TensorRT or Apache TVM for the target hardware.

Preferably, models are signed with ECDSA using an operator private key; devices verify signatures prior to model activation. Secure boot ensures only signed firmware and models execute. Model and configuration data are stored in a secure enclave; inference results include monotonic sequence counters to prevent replay. A watchdog monitors inference latency and reverts to a simpler fallback model if latency exceeds 2× target for three consecutive windows.

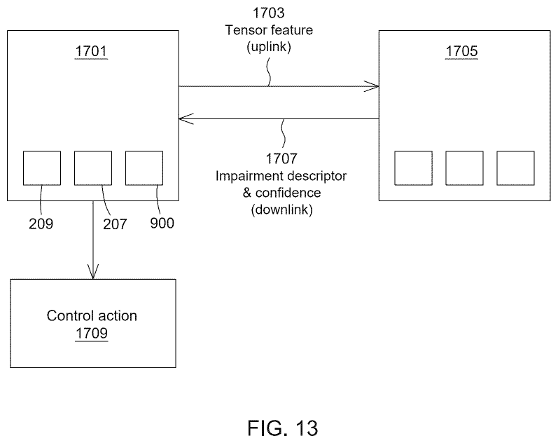

FIG. 13 illustrates, in an example embodiment, a block diagram of a remote inference sequence implemented within a communication system under control of a single operator. A communication device 1701 includes a radio front end 209 and one or more processors 201 executing an inference client module 105a configured to generate a feature tensor from in-phase and quadrature samples of a received radio-frequency signal. The feature tensor is transmitted over a network, as indicated by uplink arrow 1703, to a network inference server 1015. The network inference server 1705 comprises one or more processors 201s and a memory storing a trained machine-learning model 105, the processors being configured to apply the trained machine-learning model 105 to the received feature tensor to infer at least one channel-impairment descriptor and an associated confidence value. As indicated by downlink arrow 1707, the server returns the channel-impairment descriptor and confidence value to the communication device 1701. In response, the communication device enacts a control operation 1709 by reconfiguring at least one radio parameter in accordance with the channel-impairment descriptor, such radio parameters comprising at least one of modulation order, coding rate, transmit power, beamforming weight, Doppler compensation parameter, or channel estimation parameter. In certain embodiments, the network inference server 1015 is realized as an edge endpoint co-located with a base station, and in other embodiments as a core-network server or a satellite payload processor; secure transport and authentication may be applied to the arrows 1703 and 1707 as described herein. In some implementations, a fallback model 900 cached on the device may be applied when the network inference server 1015 is unavailable or when a service deadline is exceeded.

Although embodiments are described in detail herein with reference to the accompanying drawings, it is intended that disclosures herein not be limited to literal depictions of the embodiments illustrated by way of examples. As such, many modifications and equivalents of the machine learning based techniques of recognizing and mitigating satellite communication channel impairments, and variations in sequence of the method steps in deployment thereof, will be apparent to practitioners skilled in the art. Accordingly, it is intended that the invention encompasses scope in accordance with the following claims and their equivalents. Furthermore, it is contemplated that a particular feature described either individually or as part of an embodiment can be combined with other individually described features, or portions of other embodiments described herein. Thus, absence of described particular combinations does not preclude the inventor from claiming rights to such combinations.

What is claimed is:

1. A computer-implemented method performed by a communication node, the method comprising: receiving, by a radio front end of the communication node, in-phase and quadrature samples representative of a radio-frequency signal propagated through a wireless channel; generating, by one or more processors of the communication node, a feature representation from the in-phase and quadrature samples; applying, by the one or more processors, a trained machine-learning model stored in a memory of the communication node to the feature representation to yield at least one channel-impairment descriptor; determining, by the one or more processors, a channel-control action based on the at least one channel-impairment descriptor; and reconfiguring, by the communication node, at least one radio parameter in accordance with the channel-control action, the at least one radio parameter comprising at least one of modulation order, coding rate, transmit power, beamforming weight, Doppler compensation parameter, or channel estimation parameter.

2. The method of claim 1, further comprising converting, by the one or more processors, the at least one channel-impairment descriptor into at least one environmental parameter selected from temperature, pressure, humidity, visibility, precipitation rate, wind speed, and wind direction, and transmitting a message comprising the at least one environmental parameter.

3. The method of claim 1, wherein the feature representation comprises at least one of a time-domain representation, a frequency-domain representation, and a time-frequency representation computed from the in-phase and quadrature samples.

4. The method of claim 1, wherein the trained machine-learning model comprises a neural network selected from a convolutional neural network, a recurrent neural network, and a transformer encoder.

5. The method of claim 1, further comprising computing a confidence value associated with the at least one channel-impairment descriptor and suppressing the channel-control action when the confidence value is below a threshold.

6. The method of claim 2, wherein converting comprises applying a regression mapping trained to minimize mean-squared error between predicted environmental parameters and ground-truth weather-station measurements for a vicinity of the communication node.

7. The method of claim 1, wherein the communication node is one of a satellite, a base station, and a user equipment.

8. A computer-implemented method performed by a communication system under control of a single operator, the communication system comprising a communication device and a network inference server, the method comprising: receiving, by a radio front end of the communication device, in-phase and quadrature samples representative of a radio-frequency signal propagated through a wireless channel; generating, by one or more processors of the communication device, a feature representation from the in-phase and quadrature samples; transmitting, by the communication device, the feature representation to the network inference server over a network; processing, by the network inference server, the feature representation using a trained machine-learning model to produce at least one channel-impairment descriptor; transmitting, by the network inference server, the at least one channel-impairment descriptor to the communication device; and reconfiguring, by the communication device, at least one radio parameter in accordance with the at least one channel-impairment descriptor.

9. The method of claim 8, further comprising, by the network inference server, converting the at least one channel-impairment descriptor into at least one environmental parameter selected from temperature, pressure, humidity, visibility, precipitation rate, wind speed, and wind direction, and transmitting a message comprising the at least one environmental parameter to at least one of the communication device or a weather-data endpoint.

10. The method of claim 8, further comprising: determining, by the communication device, a confidence value associated with the at least one channel-impairment descriptor; and in response to the confidence value being below a threshold, maintaining current radio parameters without change and logging an indication of insufficient confidence.

11. The method of claim 8, further comprising, by the communication device, applying a fallback trained model stored locally to infer at least one channel-impairment descriptor when the network inference server is unavailable.

12. The method of claim 8, wherein the network inference server is an edge compute node co-located with a base station.

13. A communication system under control of a single operator, the system comprising: a communication device including a radio front end and one or more processors configured to acquire in-phase and quadrature samples of a received radio-frequency signal and generate a feature representation from the in-phase and quadrature samples; and a network inference server comprising one or more processors and a memory storing a trained machine-learning model; wherein the one or more processors of the network inference server are configured to receive the feature representation from the communication device and apply the trained machine-learning model to infer at least one channel-impairment descriptor, and wherein the communication device is further configured to receive the at least one channel-impairment descriptor and perform at least one operation selected from: adjusting a modulation order, adjusting a coding rate, adjusting transmit power, adjusting beamforming weights, or applying Doppler compensation parameters.

14. The communication system of claim 13, wherein the network inference server is further configured to convert the at least one channel-impairment descriptor into at least one environmental parameter and to transmit the at least one environmental parameter to at least one of the communication device or a weather-data endpoint.

15. The communication system of claim 13, wherein the communication device is further configured to compute a confidence value associated with the at least one channel-impairment descriptor and to suppress the at least one operation when the confidence value is below a threshold.

16. The communication system of claim 13, wherein the network inference server is one of an edge computing node, a core-network server, or a satellite payload processor.

17. The communication system of claim 13, wherein the communication device comprises one of a satellite, a base station, or a user equipment.

18. A communication node comprising a radio front end, one or more processors, and a memory storing instructions and a trained machine-learning model, the instructions when executed by the one or more processors causing the communication node to: acquire in-phase and quadrature samples of a received radio-frequency signal; compute a feature tensor from the in-phase and quadrature samples; infer, using the trained machine-learning model and the feature tensor, at least one channel-impairment descriptor; convert, using a regression mapping executed by the one or more processors, the at least one channel-impairment descriptor into at least one environmental parameter selected from temperature, pressure, humidity, visibility, precipitation rate, wind speed, and wind direction; and transmit, via the radio front end, a message comprising the at least one environmental parameter.

19. The communication node of claim 18, wherein the trained machine-learning model comprises a neural network selected from a convolutional neural network, a recurrent neural network, or a transformer encoder, and wherein the feature tensor comprises at least one of a spectrogram, a time-domain sequence, or a cyclostationary feature vector.

20. The communication node of claim 18, further comprising computing a confidence value associated with the at least one environmental parameter and withholding the message when the confidence value is below a threshold.

21. The communication node of claim 18, wherein the trained machine-learning model has been pruned or quantized to satisfy at least one of a parameter-count budget, a multiply-accumulate budget, or an inference latency budget.

22. A non-transitory computer-readable medium storing instructions that, when executed by one or more processors of a communication device under control of a single operator, cause the communication device to perform operations comprising: acquiring in-phase and quadrature samples via a radio front end; producing a feature tensor from the in-phase and quadrature samples; sending the feature tensor to a remote inference endpoint; receiving, from the remote inference endpoint, an inference output comprising at least one channel-impairment descriptor and an associated confidence value; in response to the confidence value meeting a threshold, performing at least one radio-control action based on the at least one channel-impairment descriptor; and in response to the confidence value not meeting the threshold, maintaining prior radio parameters without change and logging an indication of insufficient confidence.

23. The non-transitory computer-readable medium of claim 22, further comprising instructions that cause the communication device to apply a fallback trained model stored locally to infer at least one channel-impairment descriptor when the remote inference endpoint is unavailable.

24. The non-transitory computer-readable medium of claim 22, further comprising instructions that cause the communication device to transmit, to a weather-data endpoint, at least one environmental parameter derived from the at least one channel-impairment descriptor.

25. The non-transitory computer-readable medium of claim 22, wherein producing the feature tensor comprises computing at least one of a short-time Fourier transform spectrogram, a higher-order cumulant vector, or a Doppler spectrum.

26. The method of claim 1, wherein generating the feature representation comprises normalizing amplitude and phase of the in-phase and quadrature samples, computing a fast Fourier transform on sliding windows, and concatenating resulting spectra into the feature representation.

27. The method of claim 8, wherein transmitting the feature representation to the network inference server comprises encrypting the feature representation and authenticating the network inference server prior to transmission.

28. The communication system of claim 13, wherein the communication device is further configured to periodically transmit feature representations corresponding to different subbands, and the network inference server is configured to infer subband-specific channel-impairment descriptors.

29. The communication node of claim 18, wherein the one or more processors are further configured to receive ground-truth weather data for a vicinity of the communication node and to update parameters of the trained machine-learning model using the ground-truth weather data.

30. The method of claim 1, wherein reconfiguring the at least one radio parameter comprises selecting a coding rate from a table indexed by the at least one channel-impairment descriptor and a confidence level.
